(19) United States
(12) Patent Application Publication
(10) Pub. No.: US 2012/0024398 A1
(43) Pub. Date: Feb. 2, 2012

(54) MULTI-WAY REVERSING VALVE

(75) Inventor: Takeshi Kannoo, Tokyo (JP)

(73) Assignee: Fujikoki Corporation, Tokyo (JP)

(21) Appl. No.: 13/192,063

(22) Filed: Jul. 27, 2011

(30) Foreign Application Priority Data
Jul. 28, 2010 (JP) 2010-169241

(51) Int. Cl. F16K 11/00

(52) U.S. Cl. 137/309

(57) ABSTRACT

A multi-way reversing valve where a high-pressure passage part into which a high-pressure fluid is introduced is formed in a valve member. A valve seat part and valve chamber are in a valve body. First and second inlet/outlets (in communication with an outlet of the high-pressure passage part) are formed in the valve seat part. A low-pressure fluid is introduced into the valve chamber via the first or second inlet/outlet. An outlet-side end part of the high-pressure passage part is adapted to slide while pressed against a part of the valve seat part between the first and second inlet/outlet during a transitional stage of flow path reversal. The positions/dimensions/shapes of the outlet of the high-pressure passage part (and the first, second inlet/outlets) are designed so the high-pressure passage part outlet is in communication with at least one of the first/second inlet/outlet even during the transitional stage of flow path reversal.

### CROSS-REFERENCE TO RELATED APPLICATIONS

This application claims priority to Japanese Patent Application No. 2010-169241, filed Jul. 28, 2010, all of which is herein incorporated by reference in its entirety.

### BACKGROUND

1. Technical Field

The present disclosure relates to multi-way reversing valves, such as three-way reversing valves, four-way reversing valves, etc., employed in heat pumps, etc., and, more particularly, to rotary multi-way reversing valves that reverse flow paths by rotating a valve member by means of an actuator, such as, for example, a motor, etc., including a rotor and a stator.

2. Background Art

Heat pumps (refrigeration cycles) employed in air conditioners, refrigeration units, etc., generally include a four-way reversing valve as a flow path (flow direction) reversing means, in addition to a compressor, a gas-liquid separator, a condenser (outdoor heat exchanger), an evaporator (indoor heat exchanger), an expansion valve, etc.

As disclosed in JP Patent Publication (Kokai) No. 2001-295951 A (Patent Document 1, the entire contents of which is herein incorporated by reference in its entirety), such four-way reversing valves employed in heat pumps, etc., typically include: a valve member adapted to be rotated by an actuator, such as a motor, etc.; and a valve body in which are provided a valve seat part and valve chamber that rotatably hold the valve member. A first inlet/outlet (condenser communication port), a second inlet/outlet (evaporator communication port), a high-pressure inlet for introducing a high-pressure refrigerant from the compressor discharge side into the valve chamber, and a low-pressure outlet for evacuating a low-pressure refrigerant to the compressor suction side are provided in the valve seat part of the valve body. Flow paths are typically reversed by rotating the valve member to selectively place one of the first inlet/outlet and the second inlet/outlet in communication with one of the high-pressure inlet (valve chamber) and the low-pressure outlet through a passage part provided within the valve member.

However, such rotary four-way reversing valves are adapted to have a high-pressure refrigerant introduced into the valve chamber, while at the same time a low-pressure refrigerant is passed through the passage part within the valve member. Consequently, the differential pressure between the interior and exterior of the valve member becomes extremely large, and the valve member is pressed strongly against the valve seat part due to that differential pressure (the high-pressure refrigerant). As a result, there are such problems as there being a tendency for the valve member to not rotate smoothly when reversing flow paths, thereby making the flow path reversing operation heavy, as well as the valve member and valve seat part being prone to wear.

In order to address such problems, the present inventors have previously proposed a four-way reversing valve of the following configuration—JP Patent Application No. 2009-203926 (Patent Document 2), the entire contents of which is herein incorporated by reference in its entirety.

Specifically, as shown in FIGS. 5 and 6A-6D, the proposed four-way reversing valve 1′ includes: in order to reverse flow paths, an actuator 15, such as a motor, etc., having a rotor 16 disposed within a can 38 and a stator 17 disposed on the outer circumference of the can 38; a valve member 50 adapted to be rotated by an output shaft of a planetary gear reduction system 40 that reduces the output of the actuator 15; and a valve body 60 adapted to rotatably hold the valve member 50. A high-pressure passage part 55 adapted to have a high-pressure refrigerant introduced thereinto is formed within the valve member 50. A valve seat part 65 and a valve chamber 61 are provided in the valve body 60. The valve seat part 65 is provided with a first inlet/outlet 13 and a second inlet/outlet 14 adapted to be selectively placed in communication with an outlet of the high-pressure passage part 55. The valve chamber 61 is adapted to have a low-pressure refrigerant selectively introduced thereinto via the first inlet/outlet 13 or the second inlet/outlet 14. The dimensions and shapes of the valve member 50, etc., are designed in such a manner that, during flow path reversal, an outlet-side end part of the high-pressure passage part 55 of the valve member 50 would slide between the first inlet/outlet 13 and second inlet/outlet 14 of the valve seat part 65, and that the force in the direction in which the valve member 50 is pressed against the valve seat part 65 by the high-pressure refrigerant would be substantially cancelled.

More specifically, the valve body 60 includes an upper body 60A and a lower body 60B that are fastened by a plurality of screws 93. The valve member 50 is so disposed as to pass through a through-hole 67 provided in the center of the valve seat part 65, and is rotatably supported inside the valve body 60 via shaft bearings 81 and 82. Further, in order to place an outlet 55a of the high-pressure passage part 55 in tight contact with the valve seat part 65, an O-ring 74 and a square ring 75 are disposed at the outlet 55a. The valve member 50 is pressed upward by a coil spring 92 compressed and loaded between itself and the lower body 60B. The valve member 50 includes an inverted L-shaped shaft part 53. The high-pressure passage part 55 of an inverted L-shape or crank shape for selectively guiding the high-pressure refrigerant to the first inlet/outlet 13 or the second inlet/outlet 14 is formed within the inverted L-shaped shaft part 53. In addition, a high-pressure inlet 11 for guiding the high-pressure fluid to the high-pressure passage part 55 of the valve member 50 is provided in the bottom part of the valve chamber 61 opposite the valve seat part 65. Further, a low-pressure outlet 12 that opens into the valve chamber 61 is provided. Thus, it is adapted to function as a four-way reversing valve to be employed in the aforementioned heat pump devices.

The reference numerals 63 and 64 represent flow paths that are provided in the valve body 60 and that place the first inlet/outlet 13 and the second inlet/outlet 14 in communication with the exterior of the electrically operated valve.

In addition, in order to introduce into the can 38 the refrigerant that flows into the valve chamber 61, communication holes and gaps provided between the various members are provided at key parts of the electrically operated valve.

It is noted that, in order to facilitate a better understanding, FIG. 5 is drawn as if the first inlet/outlet 13, the second inlet/outlet 14, and the flow paths 63 and 64 are disposed further into the sheet. However, their actual positional relationship is as shown in FIGS. 6A-6D.

With the four-way reversing valve 1′, the high-pressure passage part 55 into which the high-pressure refrigerant is introduced is formed in the valve member 50, and the low-pressure refrigerant is introduced into the valve chamber 61. Further, the dimensions and shapes of the valve member 50, etc., are so designed that the force in the direction in which the valve member 50 is pressed against the valve seat part 65 by the high-pressure refrigerant would be substantially cancelled. Thus, it is possible to perform the flow path reversing operation with ease, and the valve member 50 and valve seat part 65 become less prone to wear. As a result, durability and reliability improve.

### SUMMARY

However, with the related art rotary four-way reversing valve 1′ described above, the valve member 50 is rotated from the position shown in FIG. 6A (hereinafter, first operating position) to the position shown in FIG. 6D (hereinafter, second operating position), or vice versa, to reverse flow paths, that is, to switch between, for example, a cooling operation state where the first inlet/outlet 13 and the high-pressure passage part 55 are placed in communication while the second inlet/outlet 14 and the low-pressure outlet 12 are placed in communication, and, for example, a heating operation state in which the second inlet/outlet 14 and the high-pressure passage part 55 are placed in communication while the first inlet/outlet 13 and the low-pressure outlet 12 are placed in communication.

In this case, during the transitional stage of flow path reversal (i.e., in the middle of switching from the first operating position to the second operating position, or from the second operating position to the first operating position), as shown in FIGS. 6B and 6C, the outlet-side end part 55a (the square ring 75) of the high-pressure passage part 55 of the valve member 50 slides while being pressed against the part of the valve seat part 65 between the first inlet/outlet 13 and the second inlet/outlet 14. Consequently, the outlet of the high-pressure passage part 55 is closed off by the valve seat part 65.

When the outlet side of the high-pressure passage part 55 is thus closed off during the transitional stage of flow path reversal, the high-pressure refrigerant of the compressor discharge side is generally left with no place to escape to, albeit for a short time. Therefore, unless the operation of the compressor is suspended, the pressure of the high-pressure refrigerant would rise sharply, which may result in such problems as the flow path reversing operation being disrupted, devices erratically ceasing operation due to an erroneous determination of an anomaly/failure in the device by a fail-safe mechanism, and so forth.

The present disclosure is made in view of such circumstances, and an aspect thereof is to provide a multi-way reversing valve in which the pressure of the high-pressure refrigerant is prevented from increasing excessively during the transitional stage of flow path reversal without suspending the operation of the compressor, thereby preventing problems in the flow path reversing operation, while at the same time preventing situations where devices would erratically cease operating as a result of erroneous determinations of an anomaly/failure in the device being made by a fail-safe mechanism.

In view of the aspect above, a multi-way reversing valve according to an exemplary embodiment of the present disclosure may include: a valve member adapted to be rotated by an actuator, such as a motor or the like, in order to reverse flow paths; and a valve body adapted to rotatably hold the valve member, wherein a high-pressure passage part adapted to have a high-pressure fluid introduced thereinto is formed within the valve member, a valve seat part is provided in the valve body, the valve seat part having a plurality of flow-out ports formed therein, the plurality of flow-out ports being adapted to be selectively placed in communication with an outlet of the high-pressure passage part, an outlet-side end part of the high-pressure passage part of the valve member is adapted to slide while being pressed against the valve seat part during a transitional stage of flow path reversal, and positions, dimensions, shapes and the like of the outlet of the high-pressure passage part and of the plurality of flow-out ports are designed in such a manner that, even during the transitional stage of flow path reversal, the outlet of the high-pressure passage part would always be in communication with at least one of the plurality of flow-out ports.

More preferably, a multi-way reversing valve according to an embodiment of the present disclosure may include: a valve member adapted to be rotated by an actuator, such as a motor or the like, in order to reverse flow paths; and a valve body adapted to rotatably hold the valve member, wherein a high-pressure passage part adapted to have a high-pressure fluid introduced thereinto is formed within the valve member, a valve seat part and a valve chamber are provided in the valve body, the valve seat part having a first inlet/outlet and a second inlet/outlet formed therein, the first inlet/outlet and the second inlet/outlet being adapted to be selectively placed in communication with an outlet of the high-pressure passage part, the valve chamber being adapted to have a low-pressure fluid selectively introduced thereinto via the first inlet/outlet or the second inlet/outlet, an outlet-side end part of the high-pressure passage part of the valve member is adapted to slide between the first inlet/outlet and the second inlet/outlet of the valve seat part during flow path reversal, and positions, dimensions, shapes and the like of the outlet of the high-pressure passage part, as well as of the first inlet/outlet and the second inlet/outlet are designed in such a manner that, even during a transitional stage of flow path reversal, the outlet of the high-pressure passage part would always be in communication with at least one of the first inlet/outlet and the second inlet/outlet.

The valve member and the high-pressure passage part may preferably be formed in an L-shape or crank shape as viewed from the side.

The diameter of each of the plurality of flow-out ports may preferably be adapted to be smaller than the diameter of the outlet of the high-pressure passage part.

In another preferred embodiment, the outlet of the high-pressure passage part and at least one of the plurality of flow-out ports may be located along the circumference of the same circle.

In another preferred embodiment, the offset distance among the plurality of flow-out ports may be adapted to be shorter than the diameter of the outlet of the high-pressure passage part.

With a multi-way reversing valve according to a preferred embodiment of the present disclosure, the positions, dimensions, shapes, etc., of the outlet of the high-pressure passage part and of the first inlet/outlet and the second inlet/outlet are designed in such a manner that, even during the transitional stage of flow path reversal, the outlet of the high-pressure passage part within the valve member would always be in communication with at least one of the first inlet/outlet and the second inlet/outlet. Thus, during the transitional stage of flow path reversal, the high-pressure refrigerant of the compressor discharge side is allowed to escape from the high-pressure passage part within the valve member to the valve chamber or out of the valve via the first inlet/outlet and/or the second inlet/outlet. As a result, it is possible to prevent the pressure of the high-pressure refrigerant from increasing excessively during the transitional stage of flow path reversal without suspending the operation of the compressor, thereby preventing problems in the flow path reversing operation, while at the same time preventing situations where devices would erratically cease operating as a result of erroneous determinations of an anomaly/failure in the device being made by a fail-safe mechanism.

### BRIEF DESCRIPTION OF THE DRAWINGS

FIG. 1 is a schematic sectional view showing a key part of a multi-way (four-way) reversing valve according to the first embodiment of the present disclosure.

FIGS. 2A through 2C are sectional views taken as indicated by arrowed line Y-Y in FIG. 1.

FIGS. 3A through 3C are sectional views respectively corresponding to FIGS. 2A through 2C and which show the second embodiment.

FIGS. 4A through 4C are sectional views respectively corresponding to FIGS. 2A through 2C and which show the third embodiment.

FIG. 5 is a vertical sectional view showing one example of a related art multi-way (four-way) reversing valve.

FIGS. 6A through 6D are sectional views taken as indicated by arrowed line X-X in FIG. 5.

### DETAILED DESCRIPTION

Four-way reversing valves according to embodiments of the present disclosure are described below with reference to the drawings.

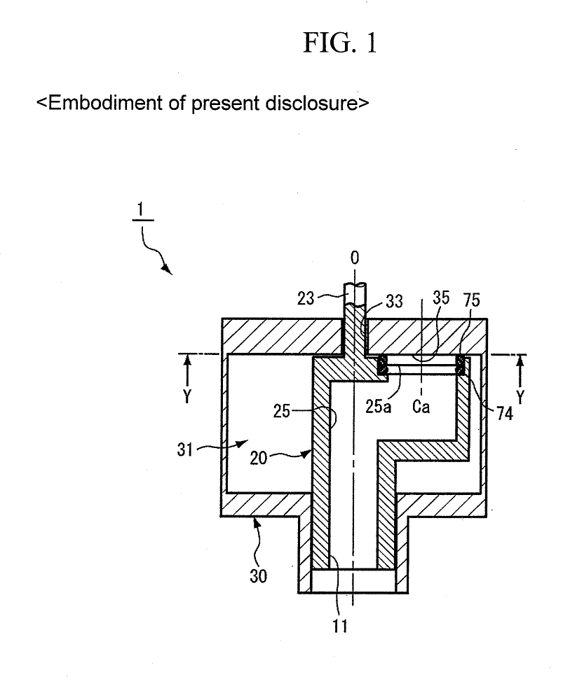

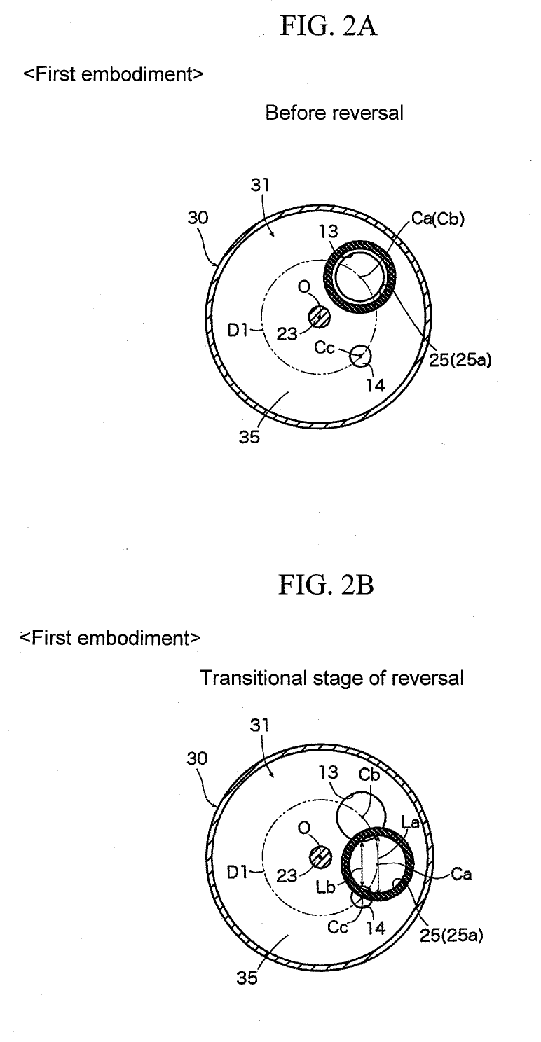

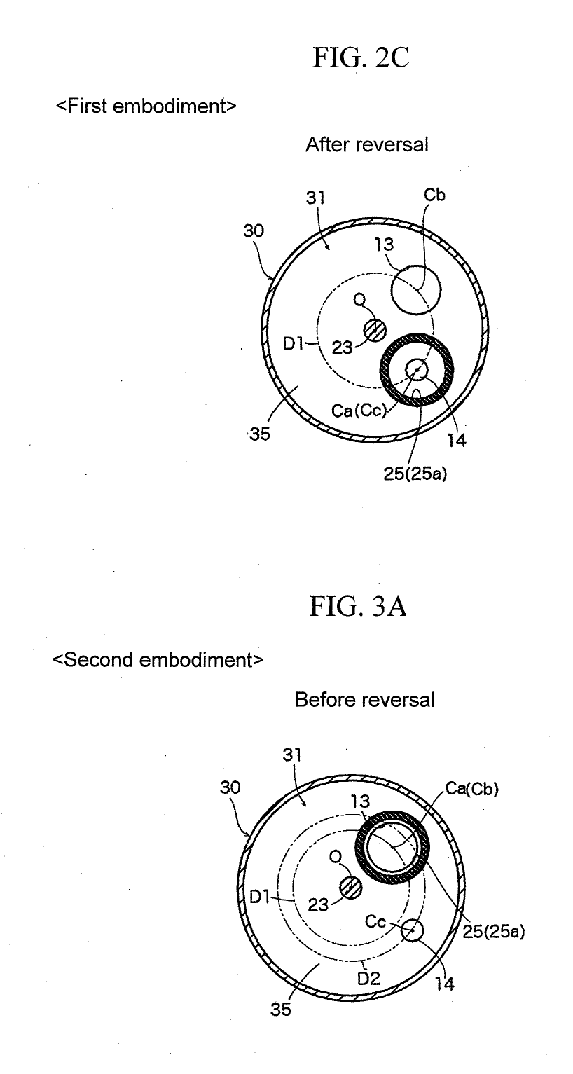

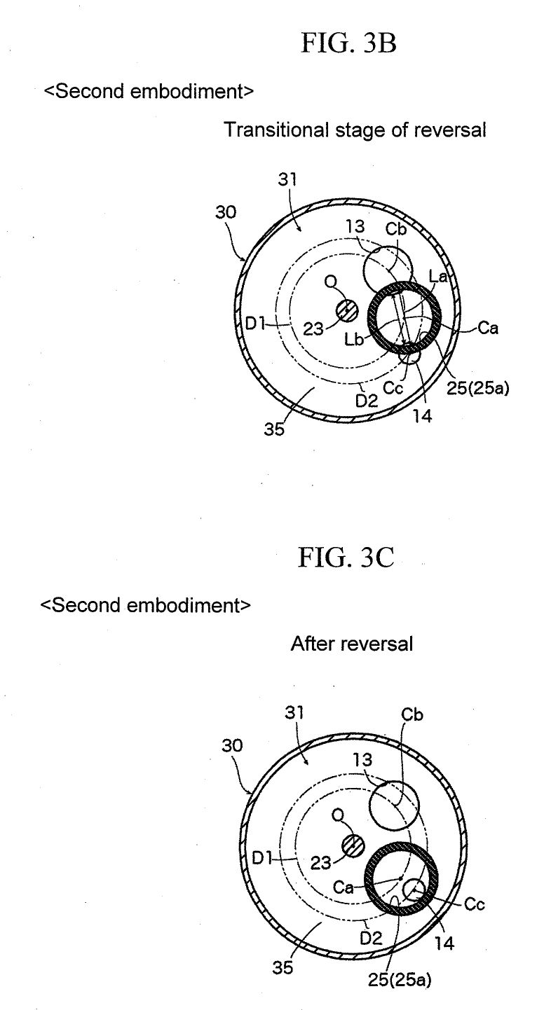

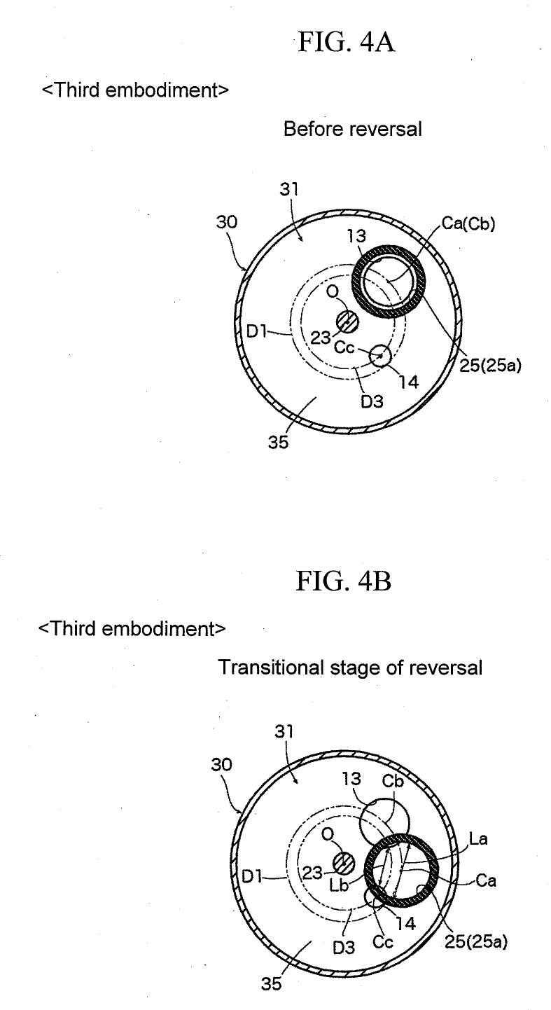

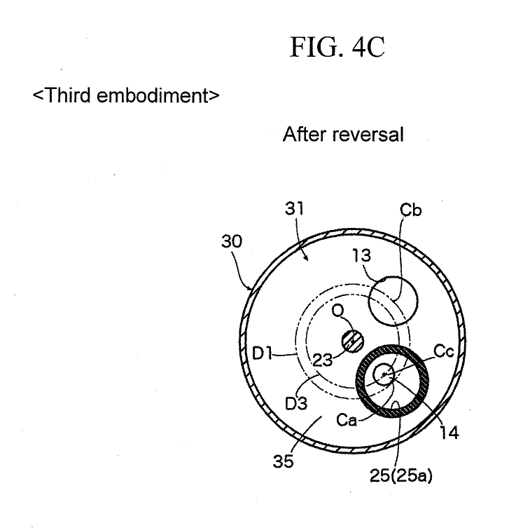

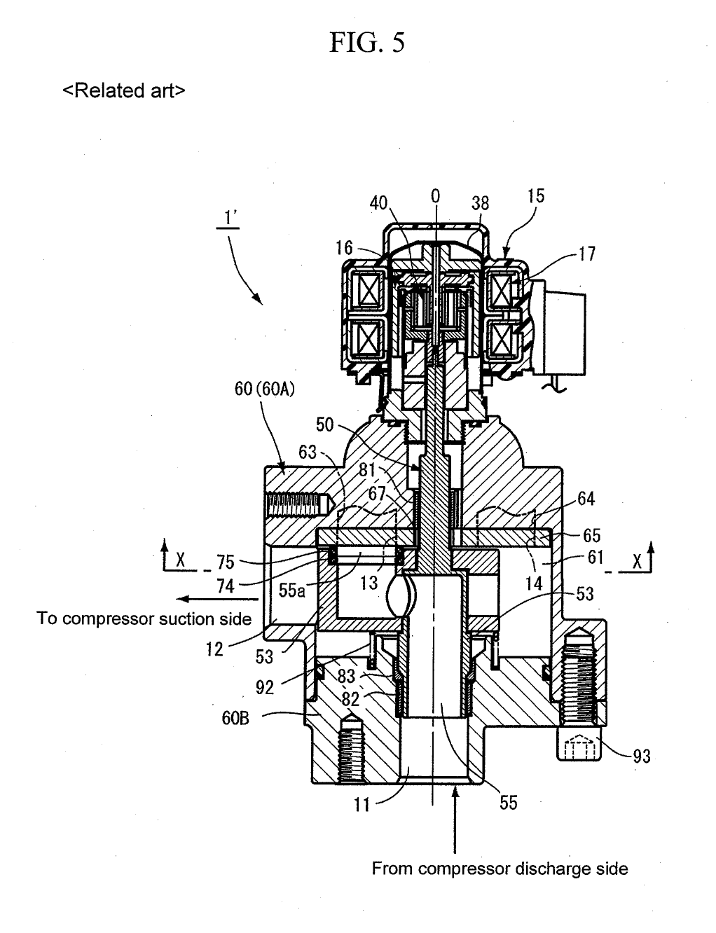

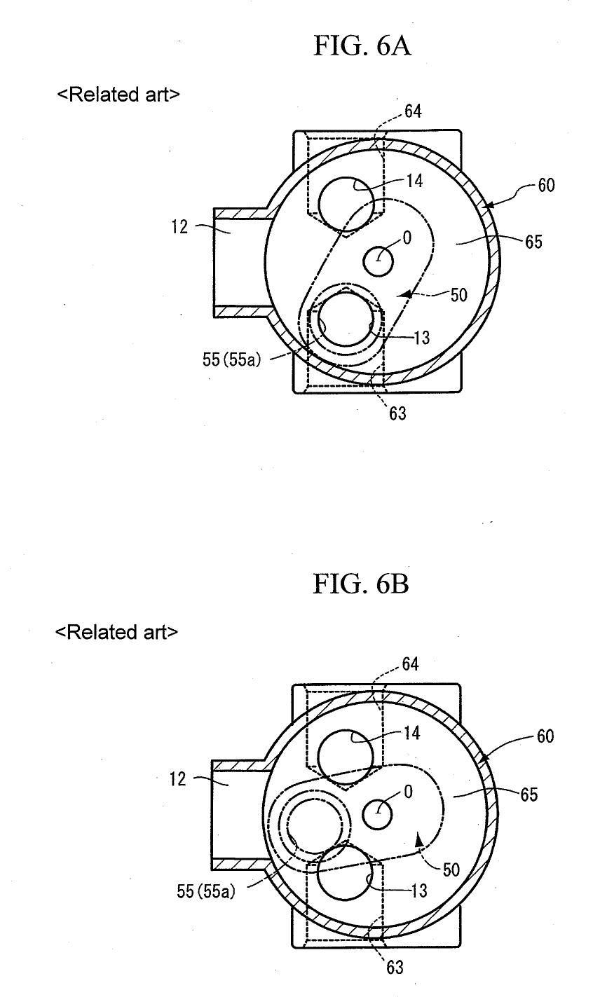

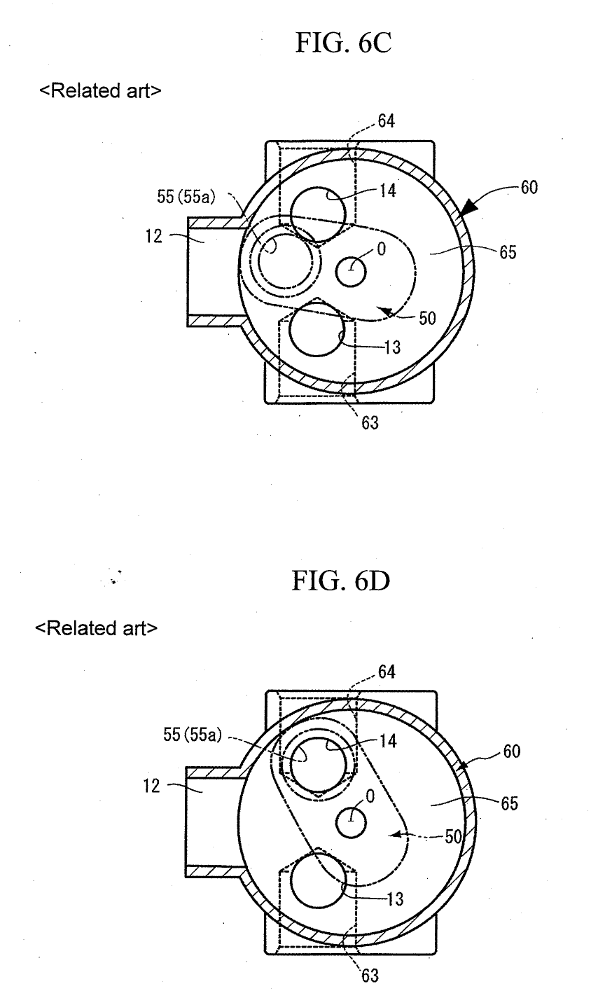

FIG. 1 is a schematic sectional view showing a key part of a multi-way (four-way) reversing valve according to the first embodiment of the present disclosure (the second and third embodiments are generally similar). FIGS. 2A through 2C are sectional views taken as indicated by arrowed line Y-Y in FIG. 1. FIGS. 3A through 3C and 4A through 4C are sectional views respectively corresponding to FIGS. 2A through 2C, and which respectively show the second and third embodiments. It is noted that, for the respective four-way reversing valves 1 of these embodiments, parts that find correspondence in the related art four-way reversing valve 1′ shown in FIG. 5 discussed above are designated with like reference numerals while omitting redundant descriptions with regard thereto.

The first through third embodiments of the present disclosure are applicable to eclectically operated valves in which a low-pressure refrigerant is introduced into the valve chamber and in which a high-pressure refrigerant is introduced into the valve member disposed within the valve chamber as discussed in connection with FIG. 5. FIG. 1 shows a schematic configuration for the valve chamber and valve member shown in FIG. 5.

As with the related art example shown in FIG. 5, the four-way reversing valve 1 of the illustrated example is also employed in heat pump devices for car air-conditioners, etc., and includes a valve member 20 that is rotated by a motor (not shown), and a valve body 30 that rotatably holds this valve member 20.

The valve member 20 is formed in an L-shape or crank shape as viewed from the side. On the upper surface thereof is provided, in a protruding manner, a support shaft 23 that is inserted into a shaft bearing hole 33 formed in the center (along rotational axis O) of an upper part (valve seat part) 35 of the valve body 30. This support shaft 23 is connected with the rotational output shaft of the actuator, such as a motor, etc., which is not shown in the drawing. A high-pressure passage part 25 into which a high-pressure refrigerant is to be introduced is formed inside the valve member 20 in a shape similar to the external shape thereof.

A high-pressure inlet 11 and a low-pressure outlet 12 (both of which do not appear in the drawing, see FIG. 5) as well as a valve chamber 31 are formed in the valve body 30. Further, a first inlet/outlet 13 and a second inlet/outlet 14 (omitted in FIG. 1), which are selectively placed in communication with an outlet 25a (the inner side of a square ring 75) of the high-pressure passage part 25 of the valve member 20 are formed in the valve seat part 35 of the valve body 30.

In addition, with respect to the four-way reversing valve 1 in the illustrated example, (center line Ca of) the outlet 25a of the high-pressure passage part 25 and (center line Cb of) the first inlet/outlet 13 are located along the circumference of the same circle (D1). The diameter of the first inlet/outlet 13 is designed to be slightly smaller than the diameter of the outlet 25a of the high-pressure passage part 25. The diameter of the second inlet/outlet 14 is designed to be considerably smaller than the diameter of the first inlet/outlet 13.

With the four-way reversing valve 1 in this example, the positions, dimensions, shapes, etc., of the outlet 25a of the high-pressure passage part 25 as well as of the first inlet/outlet 13 and second inlet/outlet 14 are designed in such a manner that the outlet 25a of the high-pressure passage part 25 would always be in communication with at least one of the first inlet/outlet 13 and the second inlet/outlet 14 even during the transitional stage of flow path reversal, that is, in such a manner that the outlet 25a of the high-pressure passage part 25 would typically never be completely closed off by the valve seat part 35 during the transitional stage of flow path reversal.

Specifically, in the first embodiment (FIGS. 2A through 2C), (center line Cc of) the second inlet/outlet 14 is located along the circumference of circle D1 mentioned above. In the second embodiment (FIGS. 3A through 3C), (center line Cc of) the second inlet/outlet 14 is located along the circumference of circle D2, which is larger than circle D1 mentioned above. In the third embodiment (FIGS. 4A through 4C), (center line Cc of) the second inlet/outlet 14 is located along the circumference of circle D3, which is smaller than circle D1 mentioned above. In all of these embodiments, offset distance (shortest linear distance) Lb between the first inlet/outlet 13 and the second inlet/outlet 14 is designed to be shorter than diameter La of the outlet 25a of the high-pressure passage part 25.

With respect to the thus configured four-way reversing valve 1, by rotating the valve member 20 from the position shown in FIG. 2A (first operating position) to the position shown in FIG. 2C (second operating position), or vice versa, flow paths are reversed, that is, switching is performed between, by way of example, a cooling operation state, in which the first inlet/outlet 13 and the high-pressure passage part 25 are placed in communication while the second inlet/outlet 14 and the low-pressure outlet 12 are placed in communication, and, by way of example, a heating operation state, in which the second inlet/outlet 14 and the high-pressure passage part 25 are placed in communication while the first inlet/outlet 13 and the low-pressure outlet 12 are placed in communication.

In this case, during the transitional stage of flow path reversal (i.e., in the middle of switching from the first operating position to the second operating position, or from the second operating position to the first operating position), as shown in FIGS. 2B, 3B and 4B, the outlet side end part (the square ring 75) of the high-pressure passage part 25 of the valve member 20 slides while being pressed against the part of the valve seat part 35 between the first inlet/outlet 13 and the second inlet/outlet 14.

With the respective four-way reversing valves 1 of the embodiments above, by, for example, designing offset distance (shortest linear distance) Lb between the first inlet/outlet 13 and the second inlet/outlet 14 to be shorter than diameter La of the outlet 25a of the high-pressure passage part 25 as discussed above, the outlet 25a of the high-pressure passage part 25 is made to always be in communication with at least one of the first inlet/outlet 13 and the second inlet/outlet 14 even during the transitional stage of flow path reversal (in FIGS. 2B, 3B and 4B, there are shown states in which the outlet 25a of the high-pressure passage part 25 slightly opens into both the first inlet/outlet 13 and the second inlet/outlet 14). Thus, during the transitional stage of flow path reversal, the high-pressure refrigerant of the compressor discharge side is allowed to escape from the high-pressure passage part 25 to the valve chamber 31 or out of the valve via the first inlet/outlet 13 and/or the second inlet/outlet 14. As a result, it is possible to prevent the pressure of the high-pressure refrigerant from increasing excessively during the transitional stage of flow path reversal without suspending the operation of the compressor, thereby preventing problems in the flow path reversing operation, while at the same time preventing situations where devices would erratically cease operating as a result of erroneous determinations of an anomaly/failure in the device being made by a fail-safe mechanism.

It is noted that the positions, dimensions, shapes, etc., of the outlet 25a of the high-pressure passage part 25, as well as of the first inlet/outlet 13 and the second inlet/outlet 14, are by no means limited to those of the embodiments above, and that various modifications are possible. For example, it is noted that the diameters of the first inlet/outlet 13 and second inlet/outlet 14 may be made the same, and that the outlet 25a of the high-pressure passage part 25, the first inlet/outlet 13, and the second inlet/outlet 14 may be of shapes other than a circle (e.g., an ellipse, a rectangle with rounded corners, etc.).

Further, although in the embodiments above, a four-way reversing valve for use in heat pump devices is addressed, the present disclosure is by no means limited as such. Instead, it is similarly applicable to a three-way reversing valve in which there are two flow-out ports (or inlet/outlets) that may be selectively placed in communication with the outlet of the high-pressure passage part (i.e., a valve in which the low-pressure outlet 12 is dropped from the embodiments above), a four-way reversing valve, five-way reversing valve, etc., in which there are three or more high-pressure flow-out ports (or inlet/outlets).

In addition, the motor that rotates the valve member may be of any type. Further, whether or not to provide a reduction system between the motor and the valve member may be determined as deemed appropriate in accordance with, for example, the specifications of the heat pump device, etc., in which the electrically operated valve in question is to be employed.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

List of Reference Numerals

1 Four-way reversing valve

11 High-pressure inlet

12 Low-pressure outlet

13 First inlet/outlet

14 Second inlet/outlet

20 Valve member

25 High-pressure passage part

25a Outlet

30 Valve body

31 Valve chamber

35 Valve seat part

What is claimed is:

1. A multi-way reversing valve comprising:
a valve member adapted to be rotated by an actuator or motor, in order to reverse flow paths; and
a valve body adapted to rotatably hold the valve member;
wherein a high-pressure passage part adapted to have a high-pressure fluid introduced thereinto is formed within the valve member;
wherein a valve seat part is provided in the valve body, the valve seat part having a plurality of flow-out ports formed therein, the plurality of flow-out ports being adapted to be selectively placed in communication with an outlet of the high-pressure passage part;
wherein an outlet-side end part of the high-pressure passage part of the valve member is adapted to slide while being pressed against the valve seat part during a transitional stage of flow path reversal; and
wherein positions, dimensions and shapes of the outlet of the high-pressure passage part and of the plurality of flow-out ports are designed in such a manner that, even during the transitional stage of flow path reversal, the outlet of the high-pressure passage part would be in communication with at least one of the plurality of flow-out ports.

2. A multi-way reversing valve comprising:
a valve member adapted to be rotated by an actuator or motor, in order to reverse flow paths; and
a valve body adapted to rotatably hold the valve member;
wherein a high-pressure passage part adapted to have a high-pressure fluid introduced thereinto is formed within the valve member;
wherein a valve seat part and a valve chamber are provided in the valve body, the valve seat part having a first inlet/outlet and a second inlet/outlet formed therein, the first inlet/outlet and the second inlet/outlet being adapted to be selectively placed in communication with an outlet of the high-pressure passage part, the valve chamber being adapted to have a low-pressure fluid selectively introduced thereinto via the first inlet/outlet or the second inlet/outlet;
wherein an outlet-side end part of the high-pressure passage part of the valve member is adapted to slide between the first inlet/outlet and the second inlet/outlet of the valve seat part during flow path reversal; and
wherein positions, dimensions and shapes of the outlet of the high-pressure passage part, as well as of the first inlet/outlet and the second inlet/outlet are designed in such a manner that, even during a transitional stage of flow path reversal, the outlet of the high-pressure passage part would be in communication with at least one of the first inlet/outlet and the second inlet/outlet.

3. The multi-way reversing valve of claim 1, wherein the valve member and the high-pressure passage part are formed in an L-shape or crank shape as viewed from the side.

4. The multi-way reversing valve of claim 1, wherein the diameter of each of the plurality of flow-out ports is adapted to be smaller than the diameter of the outlet of the high-pressure passage part.

5. The multi-way reversing valve of claim 4, wherein the outlet of the high-pressure passage part and at least one of the plurality of flow-out ports are located along the circumference of the same circle.

6. The multi-way reversing valve of claim 4, wherein an offset distance among the plurality of flow-out ports is adapted to be shorter than the diameter of the outlet of the high-pressure passage part.

7. The multi-way reversing valve of claim 2, wherein the valve member and the high-pressure passage part are formed in an L-shape or crank shape as viewed from the side.
